(19) United States
(12) Patent Application Publication
(10) Pub. No.: US 2006/0275073 A1
(43) Pub. Date: Dec. 7, 2006

(54) ATTACHMENT SYSTEM FOR ELONGATED FASTENING ELEMENTS

(75) Inventors: Josef Reszka, Pinneberg (DE); Thorsten Schumacher, Kummerfeld (DE)

Correspondence Address: BROOKS KUSHMAN P.C., 1000 TOWN CENTER, TWENTY-SECOND FLOOR, SOUTHFIELD, MI, 48075, US

(73) Assignee: CTS Fahrzeug-Dachsysteme GmbH, Hamburg (DE)

(21) Appl. No.: 11/381,249

(22) Filed: May 2, 2006

(30) Foreign Application Priority Data
May 2, 2005 (DE) 10 2005 020 778.2

(51) Int. Cl. F16B 9/00

(52) U.S. Cl. 403/243

(57) ABSTRACT

In an attachment system for elongated, transversely stiff fastening elements, the fastening elements are centered and rotatably fixed in place on fastening bolts of connecting units by terminal eyelets. The terminal eyelets open in the transverse direction and have insertable bushings that receive the bolts.

### CROSS-REFERENCE TO RELATED APPLICATIONS

This application claims priority to German application Serial No. 10 2005 020 778.2, filed May 2, 2005.

### BACKGROUND OF THE INVENTION

1. Field of the Invention

The invention relates to an attachment system for elongated, transversely stiff fastening elements, in particular, rod-like fastening elements.

2. Background Art

An attachment system is disclosed in DE 44 45 233 C1, in which a piston-cylinder aggregate is provided as the elongated, transversely stiff fastening element in the form of a pneumatic spring, the piston and cylinder sides of which have eyelets at their opposing ends that are open in the transverse direction for holding fastening bolts allocated to connecting units. The fastening bolts are guided and held in the eyelets by means of bushings, which can be inserted into the eyelets, and are axially secured to the receiving eyelet via latching with axial stop shoulders, wherein the free end area of the fastening bolt is provided with a latching groove, into which a frontal latching shoulder of the bushing engages. The bushings can also be injected into the eyelets.

Once the bushings have been inserted, the resultant axial latching by way of a radially outlying stop shoulder imparts a sufficient radially inward flexibility to the bushing, thereby enabling the insertion process, which presupposes corresponding elasticity levels for the bushing material and/or structural configurations of the bushing, e.g., segmentation. In both cases, larger wall thicknesses prove disadvantageous in terms of the required radial elasticity, while corresponding radial flexibilities, e.g., those achieved through material selection, might be undesirable depending on the conditions of use, and corresponding structural measures, e.g., segmentation, involve additional expense.

In order to avoid axial backlash, terminal latching into a latching groove of the bolt by means of a radially engaging latching shoulder of the bushing requires a corresponding dimensional stability, which results in additional expense. The insertability of the bushing in a configuration with a radially outer edge bead at the front end viewed in the direction of insertion further requires that the bushing be inserted before the fastening bolt to be accommodated is threaded in, thereby restricting the use of such an attachment system to cases in which the eyelet and fastening bolt axes align flush during assembly.

More latitude is provided by solutions of the kind known from DE 196 38 031 C2 in attachment systems for elongated, transversely stiff fastening elements, in particular pneumatic springs once again, in which the fastening bolts are designed as ball pins that engage fastening eyelets of the transversely stiff fastening elements, and are secured therein by insertable bushings, which are held axially and rotatably in the eyelets due to the shape of their contour, and themselves have dome-shaped moldings for the ball pins. Bushing fingers extending beyond the equator of the dome-shaped moldings engage the ball pin heads from the back when assembled, and can be pushed radially out into eyelet moldings for ball pin assembly, which extend over the width of the fingers in a circumferential direction, and have push-out zones lying between them on the eyelet side, wherein the fingers are to be introduced into these push-out zones by turning the bushings around the eyelet axis, and the fingers are supported in their back-engaging position relative to the ball pin with the push-out zones in a covered position.

The ball pins are not bound to a flush alignment of the bolt axis relative to the bushing axis for introduction into the bushings, i.e, for assembly purposes, which also makes it possible in such an attachment system to assemble transversely stiff, in particular rigid fastening elements between connecting units, which are offset relative to each other in the direction of the bolt axes, and from which the bolts mutually extend, so that, for assembly purposes, the bolt axes are crossed relative to the axes of the respectively receiving eyelets in the initial assembly position.

### SUMMARY OF THE INVENTION

One aspect of the invention is to design an attachment system that enables the use of a cylindrical fastening bolt in an eyelet, despite a potentially crossed position of the bolt axis relative to the eyelet axis which provides a simple structural design and favorable assembly capabilities.

According to another aspect of the invention, axial stop shoulders are provided on the fastening bolts or the respective connecting units that are fixed in place relative to the fastening bolts on the one hand, and allocated to the bushing to be inserted into the eyelet on the other hand, so that the eyelet lies between these stop shoulders with the bushing latched on the bolt. The bushing-side stop shoulder lies axially at the transition to the bushing-side latching shoulder, which is in turn spaced axially apart from the stop shoulder. The bushing can be inserted into the eyelet from both sides, and is axially blocked relative to the respective bolts extending opposite to the direction of bushing introduction. The bushing need not be molded in any way for assembling the bushing in the eyelet. The wall thickness of the bushing may be selected based on requirements associated with carrying and guiding functions, and in accordance with the circumstances of assembly. This attachment system may be used when, for example, given oppositely extending fastening bolts, the bolt axes are inclined relative to the respective eyelet axes for threading the respective fastening elements on the bolts.

The latching shoulder may consist of elastic latching fingers that extend from the bushing-side stop shoulder and run conically and radially inward on their free end. The latching fingers are received in a corresponding latching groove of the fastening bolt. The latching fingers may be used to achieve a tolerance-offsetting axial bracing. The latching fingers may have an adjustable clamping force level between the stop shoulder of the bushing and the bolt-side shoulder. The stop shoulder may be provided on the connector that carries the bolt.

Shims may be provided on one or both sides between the stop shoulders and eyelet to both improve friction conditions and offset axial tolerances.

The end portion of the bolt may be provided with a cap-like end piece axially bordering the latching groove for protecting the latching fingers of the bushing that engage the latching groove and extend radially inward at an inclination.

Assembly of fastening elements may produce an initial position in which the eyelets are open in the transverse direction relative to the bolts that can be introduced into the eyelets in which an axial shift or crossing of the axes of eyelets and bolts takes place. The attachment system of the invention utilizes the space occupied by the bushings mounted in the eyelets to offset the axial shift or crossing-induced deviations in the initial assembly position. The eyelets can be centered relative to the bolts by the bushings once the fastening element has reached its position corresponding to the final assembly position relative to the connecting units. In this case, the wall thickness of the bushing is tailored to the diameter ratio between the bolt and respective receiving eyelet and can be used to effect an adjustment. This can also be accomplished by means of cover sleeves for the bolts or insertion sleeves for the eyelets. According to the invention, various assembly circumstances can be accommodated with the same basic elements while providing an expedient assembly process.

Additional details and features of the invention will be better understood in view of the attached drawings, written description of the exemplary embodiment, and the claims.

### BRIEF DESCRIPTION OF THE DRAWINGS

FIG. 1 is a perspective view of an elongated, transversely rigid fastening element in the form of a rigid connecting rod that extends between connecting units and is linked with the connecting units via fastening bolts running opposite and parallel to each other, which engage in terminal eyelets of the fastening element and are fixed in place by bushings;

FIG. 2 is a top plan view corresponding to FIG. 1 showing the initial assembly position for the rod-shaped fastening element while threading onto the fastening bolts allocated to the connecting units; and

FIG. 3 is a diagrammatic, fragmentary exploded perspective view of the connection between the rod-like fastening element and the connecting unit.

### DETAILED DESCRIPTION OF THE PREFERRED EMBODIMENT(S)

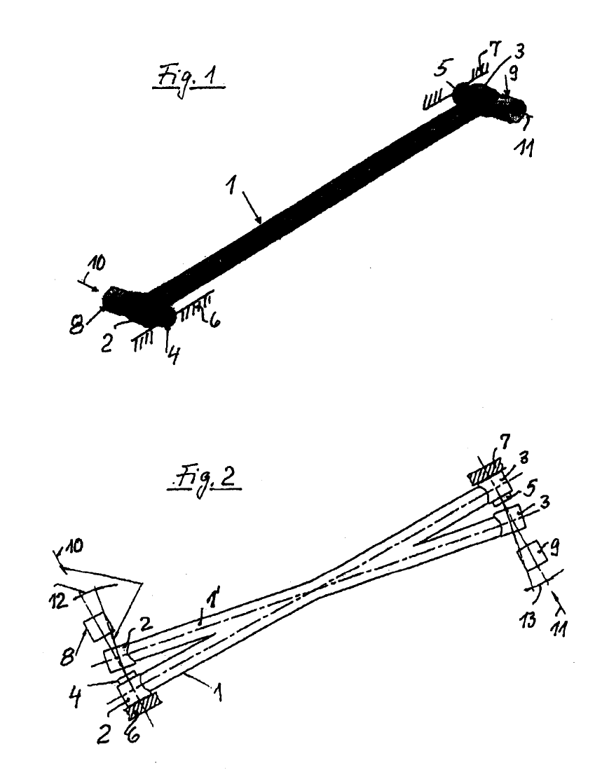

FIG. 1 presents a schematized perspective view of an elongated, transversely stiff fastening element 1, which is shown as a rod, but can also be designed as variable-length fastening element in the form of a telescoping cylinder, a pneumatic spring or the like. The opposite ends of the fastening element 1 are provided with eyelets 2, 3 open in the transverse direction, and must be linked via these eyelets 2, 3 with fastening bolts 4, 5 that are respectively allocated to a connecting unit 6, 7. The connecting unit 6, 7 can consist of rod assembly elements, frame sections or the like, e.g., of the kind used for lift-up tailgates, rear lids, hoods, or the like in motor vehicles.

The fastening bolts 4, 5 must be fixed in the respective eyelets 2, 3 via bushings 8, 9. Bushings 8, 9 may be inserted into the eyelets 2, 3 in the final assembly position, supporting them against the fastening bolts 4, 5. Arrows 10 and 11 denote the insertion devices for the bushings 8, 9.

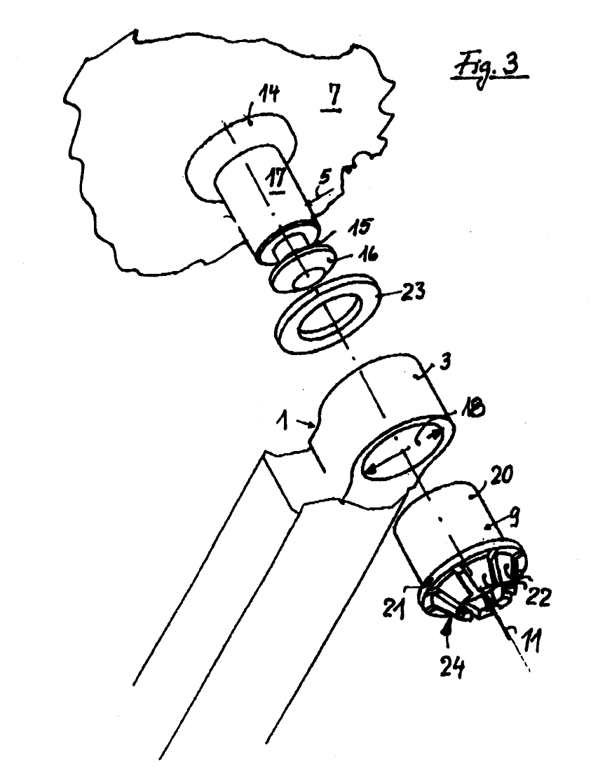

FIG. 2 shows a schematized top view of the initial position shown on FIG. 1 while threading the rod-shaped rigid fastening element 1 onto the bolts 4, 5 that are allocated to the connecting units 6, 7. The rod-shaped fastening element 1 in this initial position is at a steep angle relative to the axes of the bolts 4, 5, which are situated parallel to each other. In the depicted crossed position, the fastening element is denoted with 1′, is necessary to thread the fastening bolts 4, 5 onto the eyelets 2, 3 provided at the end relative to the fastening element 1. The crossing angle is denoted on FIG. 1 by reference numerals 12 and 13 and corresponds to the initial position between the axis of the respective bolt 4, 5 and the axis of the respective eyelet 2, 3 to be threaded in relation to the initial assembly position. Once the fastening element 1 is in the assembled position (i.e., the fastening element 1 extends perpendicular and, in terms of the axes of its eyelets 2,3, parallel to the bolts 4,5), the respective bushings 8 and 9 can overlap the bolts 4, 5 and be inserted into the respective eyelets 2, 3, occupying the space that was necessary for the crossed introduction of the respective bolts 4, 5 into the corresponding eyelets 2, 3. The bushings 8, 9 may be used to axially fix the respective eyelets 2, 3 in place relative to the accommodated bolts 4, 5.

FIG. 3 shows the structural design with respect to a connecting unit 7 and a fastening bolt 5 fixed in place relative to the connecting unit 7. The connecting unit 7, as depicted on FIG. 3, is assembled to a stop shoulder 14 of the bolts. The stop shoulder can also be formed as an annular catch of the connecting unit 7 or by a shim. The bolt 5 has a latching groove 15 in the area of its free end that is bordered by a cap-like end piece 16 of the bolt 5 at the free end of the bolt 5. A bearing section 17 of the bolt 5 is situated in the transition between the latching groove 15 and the stop shoulder 14. The fastening element 1 must be guided and supported on the bearing section 17 by the eyelet 3. The inner diameter 18 of the eyelet 3 is greater than the diameter of the bearing section 17 of the fastening bolt 5. The annular space in the final assembly position between the bearing section 17 and the inner diameter 18 of the eyelet 3 is filled by the sleeve body 20 of the bushing 9. The rearward end of the bushing 9 relative to the direction of insertion denoted by arrow 11 carries the radially outwardly projecting stop shoulder 21. Latching fingers 22 extend opposite the insertion direction denoted by arrow 11 proceeding from the stop shoulder 21, conically converging toward their free end, so that they latch into the latching groove 15. The bushing 9 is threaded onto the fastening bolt 5, thereby securing the axial position of both the bushing 9 and the eyelet 3 of the fastening element 1.

FIG. 3 further shows that a shim 23 is provided between the eyelet 3 and the stop shoulder 14 adjacent to the connecting unit 7. The shim 23 is provided to improve the frictional conditions between the stop shoulder 14 and eyelet 3, and may also function to offset axial tolerances. The invention can also encompass the replacement of the stop shoulder 14 with shims that would then be supported directly against the connecting unit 7.

The latching fingers 22 form a latching shoulder 24 to axially clamp the eyelet 3 to the connecting unit 7. According to the invention, this structure provides an axial, backlash-free accommodation of the fastening element 1 relative to the respective connecting unit 7.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An attachment system for elongated rod-like fastening elements, at least one end of the fastening elements is provided with an eyelet open in the transverse direction, the attachment system comprising:
a cylindrical fastening bolt of a connecting unit, wherein the bolt is guided in the eyelet by means of a bushing inserted into the eyelet and axially fixed relative to the eyelet;
the bushing is axially supported against the eyelet by means of a terminal stop shoulder that is spaced from the stop body;
the bushing is supported against the fastening bolt by means of a terminal latching shoulder that engages in a latching groove of the fastening bolt;
wherein the eyelet is clamped between the terminal stop shoulder of the bushing and an opposing stop shoulder of the stop body with the bushing inserted, supported axially and elastically in the direction toward the bushing via the latching shoulder; and
wherein the latching shoulder engages the latching groove of the fastening bolt and is spaced axially apart from the terminal stop shoulder of the bushing.

2. An attachment system according to claim 1, wherein the latching shoulder consists of latching fingers that proceed from the stop shoulder and conically converge toward their free end.

3. An attachment system according to claim 1 further comprising a shim that is provided at least on one side of the eyelet.

4. An attachment system according to claim 3, wherein the shim is provided between the stop shoulder adjacent to the connecting unit and the eyelet.

5. An attachment system according to claim 1, wherein the fastening bolts allocated to the two connecting units extend in an opposing, parallel direction, that the rod-shaped fastening element assumes a crossed initial position relative to the parallel fastening bolts during assembly in the initial position, and that the wall thickness of the bushings reflects the radial backlash that is given in the initial assembly position due to crossing and must be offset for the assembled state.
